(19) United States
(12) Patent Application Publication
(10) Pub. No.: US 2009/0317634 A1
(43) Pub. Date: Dec. 24, 2009

(54) ANTISMUDGE, WATER REPELLENT, AND ANTISTATIC PRESSURE-SENSITIVE OR ADHESIVE TAPE FOR PROTECTION

(76) Inventor: Kwang Suck Suh, Seongnam-Si (KR)

Correspondence Address: PARK LAW FIRM, 3255 WILSHIRE BLVD, SUITE 1110, LOS ANGELES, CA, 90010, US

(21) Appl. No.: 12/093,137

(22) PCT Filed: Nov. 8, 2006
(86) PCT No.: PCT/KR2006/004664

§ 371 Date: May 8, 2008

(30) Foreign Application Priority Data
Nov. 8, 2005 (KR) 10-2005-0106717

(51) Int. Cl. B32B 33/00; H01B 1/12; B32B 27/32; B32B 27/36; B32B 27/34; B32B 27/00

(52) U.S. Cl. 428/354; 428/343; 252/500; 428/523; 428/480; 428/474.4; 428/473.5; 428/446

(57) ABSTRACT

Disclosed is an antistatic pressure-sensitive or adhesive tape for protection. More particularly, this invention relates to an antistatic protective tape, in which, upon antistatic treatment using a conductive polymer on the exposed surface of the tape opposite the surface having an adhesive, water repellency able to increase the contact angle with respect to water so as to easily remove water drops in a water-using process and antismudge performance able to prevent the generation of smudges due to oil or to easily remove generated smudges may be imparted together, unlike conventional protective films. Further, the invention provides an antistatic composition, in which antistatic treatment using the conductive polymer and water repellent and antismudge treatment are not separately performed but are performed at the same time, so that these properties may be simultaneously exhibited in a single layer, thus decreasing the complexity of the process by one or more steps, and also provides a protective tape using the same.

### TECHNICAL FIELD

The present invention relates, in general, to an antistatic pressure-sensitive or adhesive film, cloth, or tape (hereinafter, referred to as ‘tape’) for the protection of liquid crystal displays (LCDs) and electronic parts. More particularly, the present invention relates to an antistatic composition for a protective film, suitable for imparting all of antistatic performance for preventing the attachment of impurities and minimizing the generation of static voltage upon the removal of a protective film through antistatic treatment using a conductive polymer, water repellency for causing the surface coming into contact with water to be minimized so that water can be easily removed, and antismudge performance for preventing the generation of smudges and easily removing generated smudges, in which antistatic treatment and water repellent and antismudge treatment are not separately performed, as in the conventional art, but are performed at the same time, so that a manufacturing process may be simplified by eliminating one or more steps while equivalently maintaining the above functions and exhibiting good antistatic performance, and to a protective tape using the same.

### BACKGROUND ART

In the case of a polarizing film used in LCDs, a protective film is used in order to protect the front surface of the LCD until completion of the assembly of the LCD, and also to protect the surface of the polarizing film when manufacturing or transporting the polarizing film, during the LCD module manufacturing process, and until the completion of final products. Since there is a procedure for re-attaching the protective film in the polarizing film manufacturing process and the LCD manufacturing process, the protective film should be prepared to have adhesive properties so as to be able to be removably attached several times. Further, impurities may become attached to the protective film, which is removed after the completion of all processes, in the course of transport, and as well, impurities may be attached to the surface of the polarizing film due to electrostatic voltage occurring when removing the protective film. As such, in electronic parts, in particular, in LCDs, integrated circuit chips for operation may be damaged by this high electrostatic voltage. With the goal of preventing the attachment of impurities in the above two cases and damage to operation circuit chips caused by static voltage, antistatic treatment should be conducted.

As for conventional techniques related to antistatic treatment of the protective film, Korean Patent No. 390527, entitled “Method for Producing Antistatic Layer on the Surface of Adhesive Tapes and Adhesive Tapes Thereby”, relates to a permanent antistatic pressure-sensitive or adhesive tape, which is characterized in that the base film of the tape undergoes antistatic treatment using a conductive polymer to confer antistatic performance to the pressure-sensitive or adhesive tape, such that the antistatic performance of the tape may be maintained even through heat treatment at high temperatures. According to this technique, when the conductive polymer is applied on the base film to thus manufacture the pressure-sensitive or adhesive tape, antistatic performance may be permanently maintained thanks to the properties of the conductive polymer, compared to when using conventional ionic or non-ionic surfactant type antistatic agents.

In addition, Korean Patent Application No. 10-2003-0071945, entitled “Antistatic Pressure-Sensitive or Adhesive Tapes and Production Method Thereof”, relates to a technique in which one surface of a protective film is imparted with antistatic performance using a conductive polymer, and the other surface thereof undergoes antistatic treatment using a conductive polymer and is then coated with a pressure-sensitive or adhesive material, or alternatively, the other surface thereof is coated with a mixture comprising conductive polymer and pressure-sensitive or adhesive material, thereby imparting both surfaces of the protective film with antistatic performance for preventing the attachment of impurities and minimizing the generation of electrostatic voltage. This technique for antistatic treatment using the conductive polymer is directed to an antistatic process, in which the exposed surface of the protective film during the manufacturing process and transport is subjected to antistatic treatment using the conductive polymer imparted with hard coating performance so as to increase its resistance to scratches, and the pressure-sensitive or adhesive surface is also subjected to antistatic treatment using the conductive polymer.

In the above two techniques, the exposed surface of the protective film opposite the pressure-sensitive or adhesive surface is subjected to antistatic treatment using the conductive polymer in order to assure permanent antistatic performance and high scratch resistance while maintaining transparency. However, to serve for a polarizing film for LCDs, the protective film should have water repellency for repelling water and an antismudge function for preventing the generation of smudges.

Conventionally, products having one or two layers able to exhibit the above functions have been manufactured in such a manner that antistatic treatment is performed using an ionic or non-ionic surfactant to form an antistatic layer, after which water repellent or antismudge treatment is performed on such an antistatic layer. To this end, a coating process comprising a total of two or three steps including antistatic treatment is required. Consequently, the manufacturing process becomes very complicated and the probability of generating scratches in the process increases whenever an additional layer is formed. Furthermore, the large number of manufacturing processes results in high product prices. FIG. 1 is a cross-sectional view illustrating the conventional protective film, which corresponds to the comparative example of the present invention. In the structure of the protective film, on the surface of a base film opposite the surface having an adhesive layer 13, an antistatic layer 10 imparted with antistatic performance, a water repellent layer 11, and an antismudge layer 12 are sequentially formed.

Thus, there is an urgent need for the development of a composition, which can simply exhibit not only permanent antistatic performance but also water repellency and/or antismudge performance, which are conventionally required, without decreasing transparency or distorting the characteristics of light when used in optical applications, and of a protective film to be manufactured through a simple process using such a composition.

### DISCLOSURE OF INVENTION

### Technical Problem

Accordingly, the present invention has been made keeping in mind the above problems occurring in the prior art, and an object of the present invention is to provide an antistatic pressure-sensitive or adhesive tape, not only having good antistatic performance to thus prevent the attachment of impurities during preparation, transport and use and to minimize the generation of electrostatic voltage when the film is stripped for re-working or is stripped after the completion of all processes, but also having water repellency and antismudge performance required for the protection of films for various electronic parts and LCDs.

Another object of the present invention is to provide a pressure-sensitive or adhesive tape, having permanent antistatic performance and being transparent, using a conductive polymer, and in which water repellency and antismudge performance, which are conventionally provided as separate layers, are imparted to a conductive polymer layer to thus simultaneously exhibit antistatic performance, water repellency and antismudge performance, and an antistatic composition having water repellency and antismudge performance used therein.

### Technical Solution

In order to accomplish the above objects, the present invention provides an antistatic pressure-sensitive or adhesive tape for protection having water repellency and antismudge performance, comprising a base film composed of a polymer; an antistatic layer having water repellency and antismudge performance, formed by applying an antistatic composition having water repellency and antismudge performance, comprising 100 parts by weight of an antistatic agent including a conductive polymer as an effective ingredient, 0.01˜5 parts by weight of a water repellent agent, and 0.01˜10 parts by weight of an antismudge agent, on one surface of the base film; and a pressure-sensitive or adhesive layer formed on the other surface of the base film.

In addition, the present invention provides an antistatic composition for protection having water repellency and antismudge performance, comprising 100 parts by weight of an antistatic agent including a conductive polymer as an effective ingredient; 0.01˜5 parts by weight of a water repellent agent; and 0.01˜10 parts by weight of an antismudge agent. The composition used in the antistatic layer having water repellency and antismudge performance is described later.

In addition, the present invention provides a method of manufacturing a pressure-sensitive or adhesive protective film having antistatic performance, water repellency and antismudge performance, comprising 1) mixing a conductive polymer solution, a heat-curable binder, which is to be applied so as to be dried and cured by heat, and material having water repellency and antismudge performance, therefore exhibiting two or more functions, such as antistatic, water repellent and antismudge functions in a single layer, or 2) a method comprising mixing a conductive polymer solution, a UV-curable composition including a UV-curable oligomer and monomer, which is to be applied so as to be cured by UV light, and an initiator, and material having water repellency and antismudge performance, therefore exhibiting two or more functions such as antistatic, hard coating, water repellent and antismudge functions in a single layer, and 3) applying the composition thus prepared on one surface of a base film and subjecting the other surface thereof to the application of an adhesive or to antistatic treatment using a conductive polymer and then the application of a pressure-sensitive or adhesive agent or to the application of a mixture comprising a transparent antistatic agent and a pressure-sensitive or adhesive agent.

### ADVANTAGEOUS EFFECTS

The present invention provides an antismudge, water repellent and antistatic pressure-sensitive or adhesive tape for protection and a manufacturing method thereof.

The pressure-sensitive or adhesive tape according to the present invention is suitable for use as an antistatic protective tape applicable on the film for various electronic parts and LCDs, which is characterized in that electrostatic voltage is not generated when the tape of the present invention is attached to the surface of the film for various electronic parts and LCDs and is then stripped. Further, on the pressure-sensitive or adhesive surface, antistatic performance is good, thus efficiently preventing the attachment of impurities. Furthermore, upon the antistatic treatment, the water repellent and antismudge treatment may be conducted together, such that water repellency and antismudge performance, which are properties necessary during use, may be simultaneously realized.

In the pressure-sensitive or adhesive tape of the present invention, the surface resistance is controlled to be within the range of 10⁴˜10¹⁰Ω/□ for antistatic performance. The visible light transmittance is 90% or more relative to a base film, and the contact angle with water may be controlled to be within the range of 50˜120°. As well, smudges caused by fingerprints, etc., may be easily removed.

Using the above method, a pressure-sensitive or adhesive tape for protection having good antistatic performance, water repellency and antismudge performance can be simply manufactured.

In addition, the pressure-sensitive or adhesive tape of the present invention can exhibit superior surface labeling effects thanks to good printability, compared to conventional protective tapes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### BRIEF DESCRIPTION OF THE DRAWINGS

FIG. 1 is a cross-sectional view showing the conventional pressure-sensitive or adhesive tape, which comprises three layers respectively imparted with antistatic performance, water repellency and antismudge performance;

FIG. 2 is a cross-sectional view showing the pressure-sensitive or adhesive tape according to the present invention, which comprises a single layer imparted with antistatic performance, water repellency and antismudge performance; and

FIG. 3 is cross-sectional views showing the pressure-sensitive or adhesive tape of FIG. 2 and the release film having one surface subjected to release treatment.

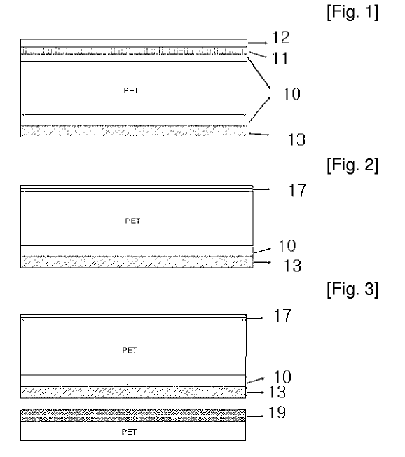

### MODE FOR THE INVENTION

Hereinafter, a detailed description will be given of the preferred embodiments of the present invention, with reference to the appended drawings.

FIG. 2 illustrates the pressure-sensitive or adhesive tape of the present invention, comprising a layer 17 having antistatic performance, water repellency and antismudge performance formed on the surface of the base film opposite the surface having a pressure-sensitive or adhesive layer 13 and an antistatic layer 10.

FIG. 3 is a cross-sectional view illustrating the pressure-sensitive or adhesive tape of FIG. 2 and the release film having one surface subjected to release treatment, in which the pressure-sensitive or adhesive layer 13 of FIG. 2 may be used in a state of adhering to the release layer 19 of the release film.

The pressure-sensitive or adhesive tape having the structure of FIG. 2 is advantageous because it can exhibit good antistatic performance, in particular, it can manifest superior antistatic performance including preventing the attachment of impurities, when serving as a protective film for a polarizing film for an LCD, and furthermore, outstanding water repellency and antismudge performance during the manufacturing process. Alternatively, there may be provided a tape, having a structure in which a conductive polymer functioning as an antistatic agent for antistatic performance is combined with a water repellent agent or an antismudge agent to form a predetermined layer, and then a water repellent layer or an antismudge layer is additionally laminated thereon. However, in this case, two or more steps are additionally required, undesirably increasing the product price. Moreover, upon the introduction of additional process, defects, such as scratches, may occur. Thus, it is preferred that desired properties be exhibited in a single layer through as simple a process as possible.

The pressure-sensitive or adhesive tape for protection able to exhibit antistatic performance and prevent the attachment of impurities, having the structure according to the present invention, is specifically described below.

Depending on the type of binder polymer having predetermined properties to be used along with the conductive polymer, a heat-curing process and a UV-curing process may be applied.

The composition to be dried or cured by heat while using the conductive polymer comprises 0.05˜10 wt % of a conductive polymer, 5˜40 wt % of a heat-curable polymer binder, and 50˜94.95 wt % of a dilution solvent, and preferably further comprises, based on 100 parts by weight of the above solution, at least one selected from among 1˜5 parts by weight of a thickener, 1˜5 parts by weight of a solvent having a high boiling point, 1˜5 parts by weight of a dispersant, 0.01˜5 parts by weight of a thermal antioxidant, and 0.01˜0.1 parts by weight of an adhesive and lubricant. In addition, 0.01˜5 parts by weight of a water repellent agent and 0.01˜5 parts by weight of an antismudge agent or 0.01˜10 parts by weight of an additive having water repellency and antismudge performance may be included.

In the conductive polymer for antistatic performance, although the conductive polymer itself has a dark color due to the double bond therein, it may manifest visible light transmittance of 90% or more relative to a base film when applied in the form of a thin film. In addition, when the conductive polymer is stably bonded with a dopant, electrical conductivity at room temperature may be permanently maintained. Thus, in the case where the conductive polymer is used as an antistatic material, the performance thereof is permanent. For these reasons, development of techniques for antistatic treatment using a conductive polymer is popular these days. Such a conductive polymer, which is exemplified by polyaniline, polypyrrole, and polythiophene, has been commercialized, and in particular, the use of PEDOT (3,4-polyethylenedioxythiophene), available from H. C. Starck, is preferable. Since PEDOT has a high visible light transmittance and contains polystyrenesulfonate as a polymer dopant, it is much more stable during a coating process than other conductive polymers. Further, even when this polymer is mixed with another polymer binder, the properties thereof are good.

In the case where the conductive polymer solution is applied alone for coating treatment, it may be separated from the surface of the base polymer, which is a coating target, or may be dissolved in a solvent. Accordingly, there is the need for the addition of a binder.

As the binder useful in the present invention, a water soluble type or a solvent type binder may be included. The binder, containing at least one functional group selected from among acryl, urethane, epoxy, amide, imide, ester, carboxyl, hydroxyl, silane, titanate, and silicate, may be used alone or in a mixture of one or more.

The exemplified binders may be selected depending on the properties of the solvent to be used, and may also be added in an amount varying depending on the required resistance. In the present invention, in the case where surface resistance falling within a range of 10⁴˜10¹⁰Ω/□ is required, the binder is provided in a mixture with the conductive polymer at a predetermined ratio.

Further, in the case where the binder includes a curable effective ingredient, to enhance the properties of a coating layer for preventing the attachment of dust, a melamine curing agent, an epoxy curing agent and catalyst, a weak-organic acid curing agent, such as paratoluenesulfonic acid or naphthalenesulfonic acid, an isocyanate curing agent such as tolyleneisocyanate or methylbisisocyanate, an amine curing agent, and an organic weak acid curing agent may be used. Further, depending on the type of curing reaction, an appropriate curing agent may be selectively used. In the case where two or more curing reactions occur, it is possible to use at least one curing agent within a range that does not decrease or does not drastically deteriorate reactivity. As mentioned above, in the case where the binder is curable, a curing agent may be mixed.

Even though an additional curing process is not introduced, a curing process may gradually progress due to the heat of room temperature and generated inside the LCD during use of the LCD. Over time, the coating film may become gradually hard in the case of using a curing agent for antistatic performance and the prevention of attachment of dust.

Below, a water repellent agent and an antismudge agent, which play important roles in the present invention, are described.

In the present invention, the water repellent agent or antismudge agent, which has been typically used to prevent fouling and corrosion of metal or wooden material, minimizes the formation of water drops on a protective film so that they can be easily removed when coming into contact with water, while exhibiting the same water repellency, and also aims to prevent the generation of smudges from polar material and oil.

To this end, since the water repellent agent and the antismudge agent should exhibit the properties of repelling polar materials including water, a slightly polar material may be used. Hence, a compound containing a silicon element and a compound containing a fluorine element are mainly used. Further, slightly polar hydrocarbon-based wax may be used.

The silicon compound may have properties of repelling water and water-based materials and may also function to decrease surface tension. Thus, according to the measurement of the contact angle with respect to water, the above compound functions such that water drops do not spread out but form on the surface at a large angle. Of silicon compounds, a siloxane compound having a functional group such as hydrocarbon is useful, in which such a functional group is oriented toward the surface after the coating process to thus repel water drops.

In addition to the silicon compound, a fluorine compound may be used to realize water repellent performance. Similarly, slightly polar fluorine may function to repel water and oil. Since the fluorine compound should be dissolved in water or solvent for a coating process, it generally has a structure containing phosphor or an ionic functional group on one side of a molecule in addition to fluorine. Such a fluorine compound may exhibit water repellency by transferring it to the surface after the coating process to thus come into contact with the air surface such that the slightly polar portion of the compound is distributed in the outermost region in order to repel water or smudge sources.

In the coating process, the water repellent agent or antismudge agent is used alone to thus exhibit the properties thereof. That is, these agents may be generally formed into separate layers in order to exhibit the corresponding effect. However, unlike other conductive polymer coatings for antistatic performance and additional properties, the present invention is characterized in that a conductive polymer for antistatic performance is imparted with water repellency and antismudge performance to enable the simultaneous exhibition of the above properties, thereby simplifying the process.

Further, due to the use of the water repellent agent and antismudge agent which are slightly polar, a pen used in marking defects or other properties of final LCDs or polarizers has poor ability to print thereon. However, in the present invention, since the material capable of exhibiting water repellency and antismudge performance is not used alone but is used along with conductive material, printability is improved thanks to the polarity of the conductive material itself, and therefore the conventional problem of poor printability is not observed.

The conductive polymer, which is used in a state of being dissolved in an organic solvent or of being dispersed in water, may be selected depending on the respective system, in which PEDOT is used in the form of a dispersion in water. As mainly used compounds therefor, silicon compound products, which are commercialized and sold by Dow Corning, in particular, silane compounds having alkyl or alkoxy, are exemplary. In addition, in consideration of compatibility with the conductive polymer and the binder polymer, siloxane compounds, having a functional group, such as alkyl, amino, alkoxy, or hydroxyl, may be used.

Further, fluorine compound products, commercially available from DuPont, may be used. These fluorine compounds may include various functional groups, for example, alkyl, alkoxy, and amino, in consideration of the compatibility.

Since these compounds are slightly polar, they may contain a predetermined functional group for compatibility with the conductive polymer and the binder polymer. Nevertheless, they have poor spreadability in the coating process due to the slightly polar properties. When spreadability is poor in the coating process, an agglomeration phenomenon may occur on the coating surface. Thus, it is preferred that a silicon compound or a fluorine compound be added for surface labeling, regardless of water repellency. Thereby, a synergetic effect of exhibiting not only spreadability upon coating but also water repellency may be expected.

Upon preparation of a coating solution including the conductive polymer, a dispersant for good dispersibility is not particularly limited but preferably includes 1-methyl-2-pyrrolidinone, 1-methyl-pyrrolidone, 2-methylpyrrolidone, or 1-methyl-3-pyrrolidiol. Further, the above compound may act as a curing agent upon drying or curing, and may also function to increase the effective conductive length of the conductive polymer thanks to good compatibility with the chain of conductive polymer, consequently enhancing conductivity.

In addition, to inhibit the deterioration of thermal oxidation, an antioxidant may be used. Examples thereof include, but are not limited to, hindered phenols, such as pentaerythrityl-tetrakis[3-(3,5-di-tertiary-butyl-4-hydroxy phenyl)-propionate], octadecyl 3-(3,5-di-tertiary-butyl-4-hydroxy phenyl)-propionate, triethylene glycol-bis-3 (3-tertiary-butyl-4-hydroxy-5-methylphenyl)propionate, 1,3,5-tris (3,5-di-tertiary-butyl-4-hydroxy benzyl S-triazine-2,4,6-(1H3H5H)trione, thioethylene bis[3-(3,5-di-tertiary-butyl-4-hydroxy phenyl)propionate], and tris-(2,4-di-tertiary-butyl phenyl)phosphate.

In addition, to control viscosity and improve dispersion, glycol and glycerol, having a high boiling point, may be used, and include at least one selected from the group consisting of ethyleneglycol, diethyleneglycol, ethyleneglycolmonomethylether, ethyleneglycolmonoethylether, ethyleneglycolmonobutylether, ethyleneglycoldiethylether, diethyleneglycoldiethylether, glycerol, and glyceroldiglycidylether.

For enhancement of wettability, spreadability, and adhesion upon coating, a lubricant, an antifoaming agent, and a leveling agent may be used. In particular, non-ionic and ionic surfactants and silicon- or fluorine-based surfactants are preferably used. The manufacturers of such materials include, but are not limited to, for example, Dupont, Dow Corning, ShinEtsu, Witco, and 3M. The lubricants, antifoaming agents, etc., manufactured and sold by the above manufacturers, may be used without limitation as long as there is compatibility with the complete solution to be used. These materials may be selectively used depending on the purposes and desired properties.

The solvent used in the coating process is appropriately selected depending on the type of conductive polymer and binder, and may be used according to the solution system, such as a water soluble type or an organic solvent type. Examples of the solvent include at least one selected from among distilled water, C1-C4 alcohols such as methanol, ethanol, isopropanol, or n-butanol, toluene, xylene, acetone, methylethylketone, ethylacetate, ethyleneglycolmonomethylether, ethyleneglycolmonoethylether, and ethyleneglycolmonobutylether. Preferably, two or more solvents having high specific gravity and low specific gravity and compatibility with the total composition may be selected from among the above solvent group and thus used in a mixture thereof, and may be contained in the coating composition in an amount of 50˜94.95 wt %.

As such, the above amount does not indicate an absolute critical range, and deviation within an appropriate range will be obvious to those skilled in the art, without departing from the scope of the present invention.

In addition to the heat-curable coating composition mentioned above, an antistatic layer may be formed using a UV-curing process. Compared to the heat-curing process, the UV-curing process enables the exhibition of hard coating properties, leading to high scratch resistance and a property of not being eliminated well by the solvent.

The UV-curable composition comprises 0.05˜20 wt % of a conductive polymer, 10˜50 wt % of a UV-curable oligomer and monomer, 0.5˜5 wt % of a photoinitiator, and 25˜89.45 wt % of a solvent. Preferably, based on 100 parts by weight of the composition, 0.1˜5 parts by weight of a surfactant for spreadability upon coating and 0.1˜5 parts by weight of a UV stabilizer may be further included, and also a water repellent agent and an antismudge agent may be added in amounts of 0.01˜5 parts by weight and 0.01˜10 parts by weight, respectively, which may be formed into a single compound or separate compounds.

The UV-curable oligomer preferably comprises acrylate/methacrylate which is monofunctional, having a functional group such as epoxy or urethane, or polyfunctional, having 2˜15 functional groups, and which may be used alone or in a mixture of two or more. The monomer comprises a monofunctional/polyfunctional acrylate/methacrylate monomer, and preferably includes a polyfunctional monomer. In the case of using only the monomer, a monomer compound having at least two functional groups and a molecular weight of 1,000 or more is preferably used, thereby realizing good coating hardness and a very hard surface layer.

The photoinitiator for initiating the curing process may be in the state of a liquid or solid, and typically, at least one selected from among benzyl dimethyl ketal, hydroxyl cyclohexyl phenylketone, hydroxydimethyl acetophenone, benzophenone, and 2,4,6-trimethylbenzoyldiphenylphosphine may be used. In the UV-curing process, when the conductive polymer is exposed to UV light, the conjugated double bond thereof is broken to thus undesirably decrease conductivity. Therefore, in order to prevent such a decrease, a UV stabilizer, such as 2,4-dihydroxybenzophenone, 2-hydroxy-4-n-octoxybenzophenone, and ethyl-2-cyano-3-3-diphenylacrylate, may be used alone or in a mixture of one or more. The photoinitiator, the UV stabilizer, and the absorbent are not limited to the above-mentioned types, because they may be selectively used depending on the types of oligomer and monomer and the wavelength of a curing apparatus upon UV curing, and on the purpose and desired properties. Useful in the UV-curable composition, the additives, such as the thickener, the lubricant, etc., and the solvent may include all types mentioned in the above heat-curing process for the same purpose.

In accordance with the water repellent and antismudge principle, the water repellent agent functions to easily remove or dry water in contact with the film through water repellent treatment. Further, when a hydrophilic compound, having the same degree of polarity as water, which is highly polar, is used, wettability is increased, and thus water is distributed over a large area. In such a case, it is difficult to remove or dry such water. Accordingly, as hydrophobic material, silane, siloxane, a fluoro compound, and wax containing an aliphatic component may be used. In addition to such fluorine, silane, and wax, any material may be used as long as it has water repellency.

In the case where the above-mentioned water repellent agent is used alone, it may be formed into a single layer 0.01˜1□ thick. However, in the present invention, the water repellent agent is preferably mixed in an amount of 0.01˜5% based on the total weight of the composition including the conductive polymer. When coating using water as a main component or coating using an organic solvent as a main component, the above agent may be selectively used in consideration of solubility.

The effects of the water repellent agent after the coating process are evaluated by the extent of spreading caused by direct spray of water or by the size of water drops, or through measurement of the contact angle using a predetermined apparatus, in which a contact angle between 60 and 120 is needed according to the specification determined by the requirement of users.

In addition, the antismudge agent is used to prevent the generation of smudges by oil and hands of human beings, and is typically represented by a dispersion of a fluoroalkyl polymer or a fluoroalkyl compound having a low molecular weight.

Further, various wax materials may be used. The effect and principle thereof are similar to the above-mentioned repelling effect. In the case where the polar compounds contained in various smudge sources adhere to the surface, the antismudge agent functions to prohibit the wetting of such compounds to the surface of the film to thus minimize the surface area thereof and thus allow easy removal from the surface.

Furthermore, according to the same principle, components stained by the fingerprints of the human, composed of mixtures of oil and water including various inorganic materials, do not remain on the surface.

As in the water repellent agent, when the antismudge agent is used alone, it may be formed into a layer 0.01˜1□ thick. On the other hand, in the case of using the conductive polymer, the antismudge agent is preferably added in an amount of 0.01˜5% based on the total weight of the composition including the conductive polymer. Upon coating mainly using water or coating mainly using an organic solvent, the above agent may be selectively used, in consideration of solubility.

The polymer film, which serves as the base film of the pressure-sensitive or adhesive tape, is exemplified by almost all polymer films made from any one selected from among ethylene-, propylene-, ester-, acryl-, imide-, amide-, styrene-based polymers, blends thereof, and copolymers thereof. Alternatively, laminate films formed by laminating respective polymer films may be used. In particular, as the protective film of the polarizing film for LCDs, polyethyleneterephthalate (PET) is preferably used. Also, the film may be selectively used depending on the required transparency and orientation angle.

As the material on which antistatic, water repellent and antismudge coating capable of simultaneously exhibiting antistatic performance, water repellency and antismudge performance may be performed, any material may be utilized, as long as it is a film for use in protection, which is exemplified by almost all polymer films made from any one selected from among ethylene-, propylene-, ester-, acryl-, imide-, amide-, styrene-based polymers, blends thereof, and copolymers thereof. Alternatively, laminate films formed by laminating respective polymer films may be used. In particular, as the protective film of the polarizing film for LCDs, PET is preferably used. Also, the film may be selectively used depending on the required transparency and orientation angle.

The water repellent and antismudge coating agent including the conductive polymer as an effective ingredient is applied on one surface of the protective film. On the other surface thereof, only an adhesive is applied to form an adhesive layer, or alternatively, materials capable of exhibiting antistatic performance, for example, a conductive polymer, a surfactant and a permanent antistatic agent, may be included in the adhesive layer to thus form an antistatic adhesive layer. In addition, a method of forming a conductive layer composed mainly of a conductive polymer and then applying an adhesive thereon may be used. Among these methods, when the method of mixing the conductive material with the adhesive layer or of forming only the conductive layer and then applying the adhesive is used, electrostatic voltage generated upon the removal of the protective film can be effectively eliminated.

The antistatic tape thus manufactured may be used in the form of tape in a state in which the pressure-sensitive or adhesive surface is wound as it is. Further, upon use of the release film, the tape may be attached to a target after removal of the release film. In this case, one surface of the release film may be subjected to antistatic treatment using a conductive polymer as an effective ingredient and then to treatment using a releasing agent. Alternatively, a coating layer composed of a mixture of the conductive polymer and the releasing agent may be formed so as to be imparted with antistatic performance, thereby preparing an antistatic tape including the release film not permitting the attachment of impurities.

The antistatic pressure-sensitive or adhesive tape according to the present invention may be used as it is, and also may be used in a state of being attached to one surface of another film, thus manufacturing various films, such as polarizing films for LCDs and protective films for electronic parts.

A better understanding of the present invention may be obtained through the following examples which are set forth to illustrate, but are not to be construed as the limit of the present invention.

<Measurement of Properties>

Measurement of Electrostatic Voltage upon Stripping: Electrostatic voltage generated when a protective tape coated with an adhesive was attached to the surface of a polarizing film for LCDs and then stripped at a rate of 300 mm/min was measured using a 718A static sensor available from 3M.

Measurement of Surface Resistance and Decay Time: The surface resistance of the outermost layer of the protective tape and the surface thereof coated with the adhesive was measured using SRM110. In addition, the upper and lower portions of the film were connected to each other using a grounding clamp, after which the decay time taken for the voltage to decrease to 100 V from 1000 V, which was the initially applied amount, was measured using Monroe CPM 288.

Measurement of Contact Angle: 10 points on a 10 cm×10 cm sized surface were measured using a surface tensiometer.

Measurement of Printability: A predetermined shape was marked on the surface using a water soluble type or organic solvent type pen or stamp, and then the degree of spreading thereof was observed.

<Preparation of Coating Solution>

Preparation of Heat-Curable Antistatic Solution: 10 g of a Dispersion of poly(3,4-ethylenedioxythiophene) (Baytron PH, available from H. C. Starck, Germany), 20 g of a urethane binder (U710, available from ALBERDINGK, Germany), 1 g of ethyleneglycol, 1 g of N-methyl-2-pyrrolidinone, and 0.01 g of a fluorine-based lubricant were mixed with 67.99 g of a solvent mixture of water and isopropylalcohol (15:85), thus preparing an antistatic coating solution.

Preparation of UV-Curable Antistatic Solution: 5 g of a dispersion of poly(3,4-ethylenedioxythiophene) (Baytron PH, available from Bayer), 5 g of a hexafunctional urethaneacrylate oligomer, 5 g of a trifunctional urethaneacryalte monomer, and 0.3 g of methylbenzoylformate were mixed with 20 g of isopropyl alcohol and 20 g of ethyleneglycolmonoethylether, thus preparing a UV-curable antistatic coating solution.

Preparation of Water Repellent Solution: A water repellent emulsion, 2-1251, available from Dow Corning, was diluted to 5% with a mixture comprising water and isopropyl alcohol mixed at 5:5, thus preparing a water repellent solution.

Preparation of Antismudge Solution: A fluoroalkyl polymer, Zonyl 8952, available from DuPont, was diluted to 5% with a mixture comprising water and isopropyl alcohol mixed at 5:5, thus preparing an antismudge solution.

Preparation of Heat-Curable Antistatic Solution Having Water Repellency and Antismudge Effects: 10 g of a dispersion of poly(3,4-ethylenedioxythiophene) (Baytron PH, available from H. C. Starck, Germany), 20 g of a urethane binder (U710, available from ALBERDINGK, Germany), 1 g of ethyleneglycol, 1 g of N-methyl-2-pyrrolidinone, 0.01 g of a fluorine-based lubricant, 0.2 g of a water repellent agent, 2-1251, available from Dow Corning, and 0.2 g of Zonyl 8952, available from DuPont, were mixed with 67.99 g of a solvent mixture of water and isopropylalcohol (15:85), thus preparing an antistatic solution.

Preparation of UV-Curable Antistatic Solution Having Water Repellency and Antismudge Effects: 5 g of a dispersion of poly(3,4-ethylenedioxythiophene) (Baytron PH, available from Bayer), 5 g of a hexafunctional urethaneacrylate oligomer, 5 g of a trifunctional urethaneacrylate monomer, 0.3 g of methylbenzoylformate, 0.2 g of a water repellent agent, 2-1251, available from Dow Corning, and 0.2 g of Zonyl 8952, available from DuPont, were mixed with 20 g of isopropylalcohol and 20 g of ethyleneglycolmonoethylether, thus preparing a UV-curable antistatic coating solution.

Preparation of Antistatic Release Agent: 10 g of a dispersion of poly(3,4-ethylenedioxythiophene) (Baytron PH, available from Bayer) as a conductive polymer, 5 g of hydroxypoly modified siloxane, and 0.15 g of a curing agent having three isocyanate groups were mixed with 30 g of acetone, thus preparing an antistatic release solution.

### Comparative Example 1

On one surface of a PET film 36 n thick, an acryl adhesive was applied to a thickness of 15□, without antistatic treatment and water repellent and antismudge treatment, thus manufacturing a film.

The film was cut to a size of 25 mm×100 mm, attached to a polarizing film, and then stripped at a rate of 300 mm/min. As such, the generated electrostatic voltage was 1320 V. Even after 600 sec of application of 1000 V, the voltage did not decay.

The contact angle was measured to be about 55 using a surface tensiometer, thus it was confirmed that water had spread out over the very large surface. Further, when the film was pressed with a finger, a dark fingerprint was observed on the surface.

In Comparative Example 1, since antistatic treatment was not performed, the voltage generated upon stripping was very high, and the generated voltage did not decay, but was present on the film for a long period of time. Further, the lack of water repellent and antismudge treatment led to a small contact angle of water and the surface of the film stained with the fingerprint.

### Comparative Example 2

On one surface of a PET film 36□ thick, a heat-curable antistatic coating solution was applied to a thickness of 0.1□ and then dried at 80° C. for 2 min. Further, a water repellent agent was applied to a thickness of 0.05□ thereon and then dried at 70° C. for 30 sec. Furthermore, an antismudge agent was applied to a thickness of 0.05□ thereon and then dried at 70° C. for 30 sec.

In addition, an acryl adhesive was applied to a thickness of 15□ on the surface of the film opposite the surface having the conductive layer, the water repellent layer, and the antismudge layer.

The surface resistance of the film was measured to be 10E8Ω/□. This film was cut to a size of 25 mm×100 mm, attached to a polarizing film, and then stripped at a rate of 300 mm/min. As such, the generated electrostatic voltage was 120 V. After application of 1000 V, the decay time was 2 sec, thus a rapid decay was not realized.

The contact angle was measured to be about 90 using a surface tensiometer. When the film was pressed with a finger, no fingerprint was observed on the surface.

Although the film thus manufactured had good antistatic performance, water repellency and antismudge performance, it was disadvantageous because the antistatic layer, the water repellent layer and the antismudge layer were separately formed in three steps, which is complicated.

### Example 1

A heat-curable antistatic solution having water repellency and antismudge effects was prepared, applied to a thickness of 0.1□ on one surface of a PET film 36□ thick, and then dried at 80° C. for 2 min. Further, on the other surface of the film, an acryl adhesive was applied to a thickness of 15□.

The surface resistance of the film was measured to be 10E7Ω/□. This film was cut to a size of 25 mm×100 mm, attached to a polarizing film, and then stripped at a rate of 300 mm/min. As such, the generated electrostatic voltage was 100 V, and the decay time after the application of 1000 V was 1.8 sec, thus a rapid decay was not realized.

The contact angle was measured to be about 92 using a surface tensiometer. When the film was pressed with a finger, no fingerprint was observed on the surface.

Consequently, the film thus manufactured was advantageous because it had superior properties and the manufacturing process was simplified by eliminating two steps, compared to Comparative Example 2.

### Example 2

A UV-curable antistatic solution having water repellency and antismudge effects was prepared, applied to a thickness of 0.1□ on one surface of a PET film 36□ thick, dried at 60° C. for 2 min, and then cured with 800 ml of light. Further, on the other surface of the film, an acryl adhesive was applied to a thickness of 15□.

The surface resistance of the film was measured to be 10E7Ω/□. The film was cut to a size of 25 mm×100 mm, attached to a polarizing film, and then stripped at a rate of 300 mm/min. As such, the generated electrostatic voltage was 100 V, and the decay time after the application of 1000 V was 1.8 sec, thus a rapid decay was not realized.

The contact angle was measured to be about 93 using a surface tensiometer. When the film was pressed with a finger, no fingerprint was observed on the surface.

The hardness of the surface, having undergone antistatic treatment and water repellent and antismudge treatment, was observed to be 2H.

Consequently, as in Example 1, the film thus manufactured was advantageous because it had superior antistatic performance, water repellency and antismudge performance, as well as good abrasion resistance and scratch resistance upon use, and the manufacturing process was simplified by eliminating two steps, compared to Comparative Example 2.

### Example 3

A heat-curable antistatic solution having water repellency and antismudge effects was prepared, applied to a thickness of 0.1□ on one surface of a PET film 36□ thick, and then dried at 80° C. for 2 min. Further, on the other surface of the film, a heat-curable conductive polymer solution was applied to a thickness of 0.1□ and then dried at 80° C. for 2 min, after which an acryl adhesive was applied to a thickness of 15□ thereon.

The surface resistance of the film was measured to be 10E7Ω/□. The film was cut to a size of 25 mm×100 mm, attached to a polarizing film, and then stripped at a rate of 300 mm/min. As such, the generated electrostatic voltage was 55 V, and the decay time after the application of 1000 V was 0.8 sec, thus a rapid decay was not realized.

The contact angle was measured to be about 92 using a surface tensiometer. When the film was pressed with a finger, no fingerprint was observed on the surface.

Consequently, the film thus manufactured was advantageous because it had superior antistatic performance, water repellency and antismudge performance, could be simply manufactured, and could minimize the generation of static voltage.

### Example 4

A heat-curable antistatic solution having water repellency and antismudge effects was prepared, applied to a thickness of 0.1□ on one surface of a PET film 36□ thick, and then dried at 80° C. for 2 min. Further, on the other surface of the film, an acryl adhesive mixed with a permanent antistatic agent was applied to a thickness of 15 □.

The surface resistance of the film was measured to be 10E7 Q/□. This film was cut to a size of 25 mm×100 mm, attached to a polarizing film, and then stripped at a rate of 300 mm/min. As such, the generated electrostatic voltage was 35 V, and the decay time after the application of 1000 V was 0.5 sec, thus a rapid decay was not realized.

The contact angle was measured to be about 93 using a surface tensiometer. When the film was pressed with a finger, no fingerprint was observed on the surface.

Consequently, the film thus manufactured was advantageous because it had superior antistatic performance, water repellency and antismudge performance, could be simply manufactured, and could minimize the generation of static voltage.

### Example 5

An antistatic release solution was applied to a thickness of 0.1□ on a PET film 25□ thick and then dried at 80° C. for 2 min. Further, the surface having antistatic release performance of the release film was attached to the surface having the adhesive of the 36□ thick film of Example 3.

The protective film thus manufactured, having the release film attached thereto, was cut to a size of 25 mm×100 mm, attached, and then stripped at a rate of 300 mm/min. As such, the generated electrostatic voltage was 60 V, and the decay time after the application of 1000 V was 0.8 sec, thus a rapid decay was not realized.

When the manufactured protective film was attached to the polarizer after the release film had been removed, the static voltage was only slightly generated, resulting in excellent antistatic performance and the prevention of the attachment of impurities.

### INDUSTRIAL APPLICABILITY

The antistatic protective tape according to the present invention can be used for LCDs or electron parts. The protective tape according to the present invention has good antistatic performance, and water repellency and antismudge performance so that it can be used to protect antistatic of LCDs or electron parts.

1-21. (canceled)

22. An antistatic pressure-sensitive or adhesive tape for protection having water repellency and antismudge performance, comprising:
a base film composed of a polymer;
an antistatic layer having water repellency and antismudge performance, formed by applying an antistatic composition having water repellency and antismudge performance, comprising 100 parts by weight of an antistatic agent including a conductive polymer as an effective ingredient, 0.01˜5 parts by weight of a water repellent agent, and 0.01˜10 parts by weight of an antismudge agent, on one surface of the base film; and
a pressure-sensitive or adhesive layer formed on the other surface of the base film.

23. The tape as set forth in claim 22, further comprising an antistatic layer including a conductive polymer as an effective ingredient between the base film and the pressure-sensitive or adhesive layer.

24. The tape as set forth in claim 23, wherein the antistatic layer and the pressure-sensitive or adhesive layer are formed into a single layer.

25. The tape as set forth in claim 22, wherein the base film is a film which is formed with any one selected from among ethylene-, propylene-, ester-, acryl-, imide-, amide-, styrene-based polymers, blends thereof, and copolymers thereof, or is a laminate film formed by laminating respective polymer films.

26. The tape as set forth in claim 23, wherein the base film is a film which is formed with any one selected from among ethylene-, propylene-, ester-, acryl-, imide-, amide-, styrene-based polymers, blends thereof, and copolymers thereof, or is a laminate film formed by laminating respective polymer films.

27. The tape as set forth in claim 24, wherein the base film is a film which is formed with any one selected from among ethylene-, propylene-, ester-, acryl-, imide-, amide-, styrene-based polymers, blends thereof, and copolymers thereof, or is a laminate film formed by laminating respective polymer films.

28. The tape as set forth in claim 22, wherein the water repellent agent comprises a hydrophobic material, a fluorooxy-alkoxy compound, wax containing an aliphatic component, fluorine, or silane.

29. The tape as set forth in claim 22, wherein the antismudge agent comprises a dispersion of a fluoroalkyl polymer or a fluoroalkyl compound having a low molecular weight.

30. The tape as set forth in claim 22, wherein the antistatic agent comprises 0.05˜10 wt % of the conductive polymer, 5˜40 wt % of a polymer binder, and 50˜94.95 wt % of a dilution solvent, and further comprises at least one selected from among 1˜5 parts by weight of a thickener, 1˜5 parts by weight of a solvent having a high boiling point, 1˜5 parts by weight of a dispersant, and 0.01˜0.1 parts by weight of an adhesive and lubricant, based on 100 parts by weight of the agent.

31. The tape as set forth in claim 30, wherein the conductive polymer comprises polyaniline, polypyrrole, polythiophene or derivatives thereof, or is poly 3,4-ethylenedioxythiophene.

32. The tape as set forth in claim 30, wherein the polymer binder comprises a water soluble type or solvent type binder, the binder containing at least one functional group selected from among acryl, urethane, epoxy, amide, imide, ester, carboxyl, hydroxyl, silane, titanate, and silicate and being used alone or in a mixture of one or more.

33. The tape as set forth in claim 22, wherein the antistatic agent comprises 0.05˜20 wt % of the conductive polymer, 10˜50 wt % of a UV-curable oligomer or monomer, 0.5˜5 wt % of a photoinitiator, and 25˜89.45 wt % of a solvent, and further comprises at least one of 0.1˜5 parts by weight of a surfactant for spreadability upon coating and 0.1˜5 parts by weight of a UV stabilizer, based on 100 parts by weight of the agent.

34. The tape as set forth in claim 33, wherein the UV-curable oligomer comprises acrylate/methacrylate which is monofunctional having a functional group of epoxy or urethane or polyfunctional having 2˜15 functional groups and which is used alone or in a mixture of two or more, and the monomer comprises a monofunctional/polyfunctional acrylate/methacrylate monomer or a polyfunctional monomer, in which, when the monomer is used alone, a monomer having at least two functional groups and a molecular weight of 1,000 or more is used.

35. The tape as set forth in claim 33, wherein the conductive polymer comprises polyaniline, polypyrrole, polythiophene or derivatives thereof, or is poly 3,4-ethylenedioxythiophene.

36. An antistatic composition for protection having water repellency and antismudge performance, comprising:
100 parts by weight of an antistatic agent including a conductive polymer as an effective ingredient;
0.01˜5 parts by weight of a water repellent agent; and
0.01˜10 parts by weight of an antismudge agent.

37. The composition as set forth in claim 36, wherein the water repellent agent comprises a hydrophobic material, a fluorooxy-alkoxy compound, wax containing an aliphatic component, fluorine, or silane.

38. The composition as set forth in claim 36, wherein the antismudge agent comprises a dispersion of a fluoroalkyl polymer or a fluoroalkyl compound having a low molecular weight.

39. The composition as set forth in claim 37, wherein the antismudge agent comprises a dispersion of a fluoroalkyl polymer or a fluoroalkyl compound having a low molecular weight.

40. The composition as set forth in of claim 36, wherein the antistatic agent comprises 0.05˜10 wt % of the conductive polymer, 5˜40 wt % of a polymer binder, and 50˜94.95 wt % of a dilution solvent, and further comprises at least one selected from among 1˜5 parts by weight of a thickener, 1˜5 parts by weight of a solvent having a high boiling point, 1˜5 parts by weight of a dispersant, and 0.01˜0.1 parts by weight of an adhesive and lubricant, based on 100 parts by weight of the agent.

41. The composition as set forth in claim 40, wherein the conductive polymer comprises polyaniline, polypyrrole, polythiophene or derivatives thereof, or is poly 3,4-ethylenedioxythiophene.

42. The composition as set forth in claim 40, wherein the polymer binder comprises a water soluble type or solvent type binder, the binder containing at least one functional group selected from among acryl, urethane, epoxy, amide, imide, ester, carboxyl, hydroxyl, silane, titanate, and silicate and being used alone or in a mixture of one or more.

43. The composition as set forth in claim 36, wherein the antistatic agent comprises 0.05˜20 wt % of the conductive polymer, 10˜50 wt % of a UV-curable oligomer or monomer, 0.5˜5 wt % of a photoinitiator, and 25˜89.45 wt % of a solvent, and further comprises at least one of 0.1˜5 parts by weight of a surfactant for spreadability upon coating and 0.1˜5 parts by weight of a UV stabilizer, based on 100 parts by weight of the agent.

44. The composition as set forth in claim 43, wherein the UV-curable oligomer comprises acrylate/methacrylate, which is monofunctional having a functional group of epoxy or urethane or polyfunctional having 2˜15 functional groups and which is used alone or in a mixture of two or more, and the monomer comprises a monofunctional/polyfunctional acrylate/methacrylate monomer or a polyfunctional monomer, in which, when the monomer is used alone, a monomer having at least two functional groups and a molecular weight of 1,000 or more is used.

45. The composition as set forth in claim 43, wherein the conductive polymer comprises polyaniline, polypyrrole, polythiophene or derivatives thereof, or is poly 3,4-ethylenedioxythiophene.
